(19) United States
(12) Patent Application Publication
(10) Pub. No.: US 2023/0256445 A1
(43) Pub. Date: Aug. 17, 2023

(54) Electrically Controlled Nanofluidic DNA Sluice for Data Storage Applications

(71) Applicant: The Board of Trustees of the University of Illinois, Urbana, IL (US)

(72) Inventors: Jean-Pierre Leburton, Urbana, IL (US); Xuiling Li, Champaign, IL (US); Nagendra B Athreya, Urbana, IL (US); Apratim Khandelwal, Urbana, IL (US)

(21) Appl. No.: 18/169,041

(22) Filed: Feb. 14, 2023

Related U.S. Application Data
(60) Provisional application No. 63/310,566, filed on Feb. 15, 2022.

(51) Int. Cl. B01L 3/00

(52) U.S. Cl. CPC B01L 3/502761; B01L 3/502707; B01L 2200/0647; B01L 2300/0645; B01L 2300/168; B01L 2400/0421

(57) ABSTRACT

The use of DNA or other charged biomolecules for data storage can include the use of devices to manipulate the biomolecules in solution, e.g., to store and later to selectively read out selected samples of stored biomolecules. Systems and methods provided herein facilitate the electrical manipulation of DNA or other charged biomolecules for data storage or other applications by applying voltages to sets of electrodes arranged along the length of channels of microfluidic devices. The magnitudes and signs of the applied voltages can be controlled to collect DNA into a channel, to retain the collected DNA in the channel for later use, and then to expel the DNA from the channel for readout (e.g., by a pore sequencer integrated into the same microfluidic device as the channel). Such storage channels can have rectangular cross-sections or otherwise include electrodes having substantially planar geometry.

### CROSS-REFERENCE TO RELATED APPLICATION

This application claims priority to U.S. Provisional Patent Application No. 63/310,566, filed Feb. 15, 2022, the contents of which are incorporated by reference. This application also incorporates by reference the contents of U.S. Non-Provisional patent application Ser. No. 16/593,450, filed Oct. 4, 2019.

### BACKGROUND

It is desirable in a variety of applications to control the motion or location of molecules (e.g., large biomolecules like deoxyribonucleic acid (DNA)) within a microfluidic system. For example, microfluidic channels, valves, and other elements can be used to control the provision of single nucleotides to microfluidic bioreactor chambers, allowing arbitrary polynucleotides (e.g., DNA, ribonucleic acid (RNA)) to be synthesized. However, available controllable microfluidic elements (e.g., valves) are often limited with respect to the rate and degree to which they can be turned on and off, making certain microfluidic applications difficult to implement.

### SUMMARY

In a first aspect, a device is provided that includes: (i) a substrate having a substantially planar surface; (ii) three electrodes disposed on the substrate; and (iii) an overlayer disposed on the substrate, wherein the overlayer, in combination with a portion of the substantially planar surface, forms a cavity that defines a channel, wherein the three electrodes are disposed on the portion of the substantially planar surface and separated from each other along a long axis of the channel.

In a second aspect, a method is provided that includes: (i) during a first period of time, applying a first set of voltages relative to a ground potential of an electrolyte to three electrodes of a device, wherein the device additionally includes: (a) a substrate having a substantially planar surface, wherein the three electrodes are disposed on the substrate, and (b) an overlayer disposed on the substrate, wherein the overlayer, in combination with a portion of the substantially planar surface forms a cavity that defines a channel that contains the electrolyte, wherein the three electrodes are disposed on the portion of the substantially planar surface and separated from each other along a long axis of the channel, wherein an electrolyte is disposed within the channel, wherein applying the first set of voltages to the three electrodes electrostatically attracts a negatively charged biomolecule into the channel; (ii) during a second period of time that is subsequent to the first period of time, applying a second set of voltages relative to the ground potential of the electrolyte to the three electrodes so as to electrostatically retain the negatively charged biomolecule inside the channel; and (iii) during a third period of time that is subsequent to the second period of time, applying a third set of voltages relative to the ground potential of the electrolyte to the three electrodes so as to electrostatically expel the negatively charged biomolecule from the channel.

In a third aspect, a method for fabricating a device is provided that includes: (i) forming three electrodes on a substantially planar surface of a substrate; and (ii) disposing an overlayer on the substrate, thereby forming a channel that is defined by a cavity formed by a combination of the overlayer and a portion of the substantially planar surface such that the three electrodes are disposed on the portion of the substantially planar surface and separated from each other along a long axis of the channel.

In a fourth aspect, a non-transitory computer-readable medium is provided having stored thereon program instructions that, upon execution by a computing device, cause the computing device to perform the method of the second aspect or third aspect.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1A illustrates aspects of an example device.

FIG. 1B illustrates aspects of an example device.

FIG. 2 depicts a device and aspects of a method for fabricating the device, according to example embodiments.

FIG. 3 depicts factors involved in the operation of devices as described herein and experimental data related thereto, according to example embodiments.

FIG. 4 depicts simulated and experimental results relating to the operation of devices as described herein, according to example embodiments.

FIG. 5 depicts a device, a method for operating the device, and experimental results related to the operation of the device, according to example embodiments.

FIG. 6 depicts aspects of a device and simulated results relating to the operation of the device, according to example embodiments.

FIG. 7 depicts aspects of a device and simulated results relating to the operation of the device, according to example embodiments.

FIG. 8 illustrates a flowchart of an example method.

FIG. 9 illustrates a flowchart of an example method.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

### I. OVERVIEW

A variety of contemporary applications involve DNA or other large biomolecules (e.g., single- or double-stranded DNA, RNA, polypeptides). Some of these applications involve sequencing or otherwise detecting information from the sequence, secondary (or tertiary, etc.) structure of the biomolecule, modifying such aspects of the biomolecule, and/or modifying or generating such biomolecules (e.g., synthesis of specified short sequences of DNA). Some of these applications may be related to healthcare, e.g., sequencing a patient's DNA to diagnose a disease or direct a course of treatment, generating a specified RNA as part of an mRNA vaccine, modifying a DNA to create a DNA-based drug. Some of these applications may be substantially unrelated to healthcare. For example, DNA-based computation, DNA-based data storage and retrieval, DNA origami or related DNA-based nanostructure fabrication, DNA-mediated chemistry, DNA-mediated combinatorics for, e.g., drug discovery, etc.

Many of these applications can be facilitated or improved by the ability to accurately manipulate the motion and/or location of the DNA or other biomolecules of interest. Such manipulations are facilitated where the biomolecule of interest is charged (e.g., as DNA is negatively charged), allowing controlled electrical fields to be used to exert controlled forces on the biomolecules in order to collect, store, and later release such biomolecules from a storage element (e.g., as part of a DNA-based data storage system), to control the motion of such biomolecules through a lab-on-chip (LOC) or other microfluidic device, to gate the ability of such biomolecules to move into/through channels or other elements/regions of a microfluidic device, or to manipulate such biomolecules in some other way. To do so, microfluidic devices can include electrodes disposed proximate to electrolytes or other biomolecule-containing solutions in order to allow relatively low-magnitude voltages (e.g., on the order of a few volts relative to a ‘ground’ potential in the electrolyte) to be applied to the electrodes in order to effect the manipulation of the biomolecules.

To enhance the performance of such devices, the electrodes can be disposed proximate to channels (e.g., circular channels, rectangular or otherwise-configured channels having planar interior surfaces on which electrodes can be disposed). This can be done so that the enclosing nature of the channel geometry maintains the biomolecules of interest in proximity to the electrodes, allowing a specified action (e.g., retention of DNA in a storage channel) to be accomplished using lower-magnitude electrode voltages.

One application of such a device is the selective storage and release of DNA or other charged biomolecules as part of a selective-access biomolecule-based data storage system. A sample of DNA (or some other charged information-encoding biomolecule, like RNA) can be created to represent payload information (e.g., by specifying the sequence of the DNA, by nicking the DNA in an information-representative pattern, by tagging the DNA at one or more locations, by selective nucleotide replacement, and/or some other information-encoding method). The sample can then be collected into a storage channel of a device as described herein by applying controlled voltages to electrodes within the channel. The applied voltages can then be specified to maintain the DNA within the storage channel (e.g., even in the present of fluid flow through the channel) until it is desired to read out the information from the DNA. At such a point, the applied voltages can then be specified to expel the DNA from the channel, and optionally to direct the expelled DNA to a readout system (e.g., a nanopore sequencer, which may be incorporated into the same microfluidic system as the storage channel, e.g., by being formed on the same substrate). A DNA data storage system (or storage system based on some other charged biomolecule) could include a plurality of such DNA storage channels, each containing a respective different payload of information-bearing DNA, such that specific information of interest (e.g., an image) can be retrieved by selectively releasing and reading out a corresponding sample of stored DNA (e.g., DNA that is stored in a specific storage channel and that has encoded therein a representation of the image in the sequence of the DNA, a pattern of nicking of the DNA, etc.).

In an example embodiment, such a storage channel could include three electrodes separated from each other along a long axis of the channel, such that patterns of voltages applied thereto (e.g., a pattern of polarities of the applied voltages relative to a ‘ground’ potential of an electrolyte disposed within the channel) can be controlled over time to selectively collect DNA into the storage channel, to maintain the collected DNA within the storage channel, to expel and/or release the DNA from the storage channel, and/or to manipulate DNA in some other manner. The specific pattern and magnitude of the applied voltages could be specified based on the properties of the DNA or other target charged biomolecule (e.g., an average size or mass, a charge or charge-to-mass ratio, a length), the geometry of the channel (e.g., a height of the channel), the properties of the electrolyte (e.g., a molarity of charged ions present in the electrolyte), the presence and/or magnitude of fluid flow through the channel, or some other considerations so as to reliably manipulate the DNA while reducing the magnitude of the necessary applied voltages.

It is possible to form such channels, with electrodes in close proximity thereto, in a variety of ways. For example, patterns of strained planar materials (e.g., AlN) could be formed on a substrate along with electrode materials such that the strained materials, when released form the substrate (e.g., by etching an underlying sacrificial material), result in the formation of cylindrical channels with electrodes formed thereon/therein by the patterns of strain causing the strained materials and the electrodes formed thereon to ‘roll’ into a cylindrical enclosing geometry. Alternatively, such channels can be formed by forming electrodes (an optionally additional structures, e.g., insulating layers) on a substantially planar surface of a substrate. An overlayer can then be disposed on the substrate (e.g., by forming the overlayer separately and then adhering it to the substrate, or by forming the overlayer in place on the substrate) such that the overlayer, in combination with at least a portion of the substantially planar surface of the substrate, defines a channel. Such a channel will have at least one planar wall (the portion defined by the portion of the substantially planar surface of the substrate), and may have a variety of geometries, depending on the geometry of the overlayer (e.g., a rectangular geometry).

Note that a ‘substantially planar surface’ of a substrate on which are disposed electrodes and which forms part of a channel for storage or manipulation of charged biomolecules as described herein need not be perfectly planar. Indeed, such a surface could be curved or otherwise shaped according to an application such that the shape deviates from perfect planarity in a manner that renders it still ‘substantially’ planar relative to the scale of the channel partially defined thereby. This could include the ‘substantially planar’ surface of the substrate differing, in a direction orthogonal to a ‘mean’ plane that is on average parallel to the surface, from such a mean plane by no more than 15% (or 10%, or 5%) of a width of the channel at any location across the substantially planar surface. For example, the ‘substantially planar’ surface of the substrate could be a curved portion of a cylindrical surface having a radius sufficiently large, relative to the width of the channel, that the portion of the cylindrical surface that forms part of the channel is still ‘substantially planar.’

Such a substrate can include interconnects (e.g., contact pads) to facilitate application of controlled voltages to the electrodes by external systems. Additionally or alternatively, the substrate can have formed thereon/therein transistors, amplifiers, capacitors, diodes, gates, controllers, memories, clocks, or other circuits to facilitate the application of specified patterns of voltages to the electrodes of the channel in order to collect DNA into the channel, maintain collected DNA in the channel, expel DNA from the channel, permit collected DNA to exit the channel, and/or to manipulate DNA or other charged biomolecules of interest in some additional or alternative manner.

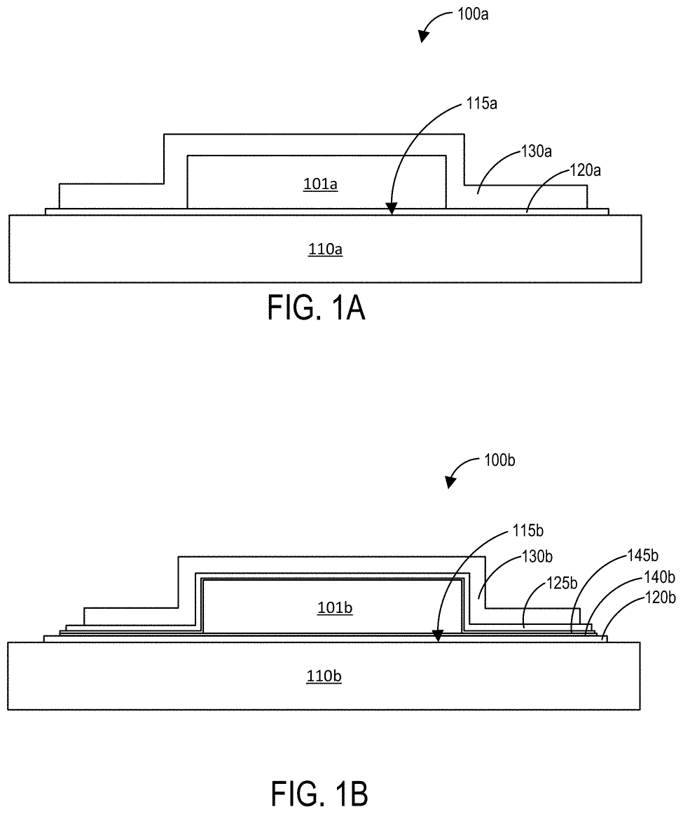

FIG. 1A depicts, in cross-sectional view, aspects of such a device 100a. The device 100a includes a substrate 110a that has a substantially planar surface 115a on which is formed a number of electrodes 120a, e.g., three or more electrodes. The device 100a also includes an overlayer 130a disposed on the substrate 110a such that the overlayer 130a in combination with the substantially planar surface 115a define a channel 101a (which extends into and/or out of the plane of FIG. 1A). The electrodes 120a are disposed on the substrate 110a such that they are separated from each other along the long axis of the channel 101a (i.e., into and/or out of the plane of FIG. 1A).

As depicted, the channel 101a has a rectangular geometry, however, alternative geometries are possible. The geometry of the channel 101a could be such that the face of the channel opposite the substantially planar surface 115a is substantially parallel to the substantially planar surface 115a to ensure that electrical field conditions are substantially the same across the width of the channel (the horizontal direction in FIG. 1A). The height of the channel (the vertical direction in FIG. 1A) could be specified to ensure that, for a particular level of applied electrode voltage, a particular DNA manipulation can be reliably accomplished using the device 100a (e.g., such that substantially no DNA collected in the channel 101a is able to escape the channel 101a). For example, the channel 101a could have a height that is less than 110 microns, or less than 30 microns.

The overlayer could be composed of a variety of materials (e.g., polydimethylsiloxane or other polymeric materials, alumina or other inorganic materials formed, e.g., by CVD, PVD, sputtering, or other additive processes performed directly on the substrate 110a). The method of forming the overlayer 130a (and, optionally, of disposing the overlayer on the substrate in examples wherein the overlayer is formed separately, e.g., via a molding process) can be specified such that the channel 101a has a desired geometry or other properties. The overlayer 130a could be formed by molding (e.g., of polydimethylsiloxane in a mold) and later adhesion to the substrate 110a (e.g., by applying a vacuum ultraviolet ozone environment to a sapphire, alumina, or other substrate material and/or passivation layers or other structures formed thereon and then disposing the formed overlayer thereon). Such a molded overlayer 130a could include additional features or elements formed therein and/or disposed thereon/therein in order to e.g., provide additional elements of a microfluidic system that includes the channel 101a. For example, such a microfluidic system could include features for additional channels (e.g., an array of channels for a DNA-based data storage systems), elements for writing information into DNA, elements for reading out information from DNA (e.g., arrays of elements to linearize DNA for readout, nanopore sequencer elements and/or elements supportive of such), interconnects to facilitate fluidic connections with pumps or other additional microfluidics devices/systems, etc.

The electrodes 120a could be formed from gold or some other material according to an application. The electrodes 120a could be formed from materials that are inherently biocompatible (e.g., gold) and/or that are inherently resilient against degradation by exposure to electrolyte solutions and/or biological materials (e.g., by forming a self-limiting layer of oxide) and/or could be coated in material(s) to protect the electrodes from a biological environment or vice-versa (e.g., by being coated in polyimide or some other biocompatible polymer material, by having a passivation layer formed thereon from inorganic material(s)).

The substrate 110a could be formed from a variety of materials according to an application. For example, the substrate 110a could include sapphire. In some examples, the substrate 110a and/or the overlayer 130a could be composed of transparent materials (e.g., sapphire, polydimethylsiloxane) in order to facilitate optical interrogation of the contents of the channel 101a using one or more wavelengths of visible light (e.g., to fluorescently measure an amount of DNA that is present in the channel 101a). In such examples, the electrodes 120a could also be composed of transparent materials (e.g., indium tin oxide (ITO)) and/or could have geometries specified to reduce interference with optical interrogation of the contents of the channel 101a.

As noted above, providing the electrodes 120a in close proximity to a channel 101a of specified height allows the voltages necessary to effect the desired manipulations of DNA to be reduced, e.g., to voltages less than 2 volts relative to a ‘ground’ potential of the electrolyte disposed within the channel 101a. Such desired manipulations could include collection of DNA into the channel 101a from a first end of the channel (e.g., by applying attractive positive voltages to first and second electrodes that are closer to the first end than a third electrode to which is applied a repulsive negative voltage), retention of collected DNA within the channel 101a following collection (e.g., by applying an attractive positive voltage the second, middle electrode and repulsive negative voltages to the first and third electrodes), and/or expulsion of collected DNA from a second end of the channel (e.g., by applying repulsive negative voltages to first and second electrodes).

The device 100a could have several variants. For example, an insulating layer could be disposed on the electrodes in order to insulate them from the electrolyte in the channel, to reduce the change of ohmic conduction through the electrodes into the electrolyte, and/or to protect the electrodes from the electrolyte in some other respect. Additionally or alternatively, the electrodes could be formed to fully surround the channel, thereby reducing the voltage necessary to reliably manipulate DNA and/or reducing the voltages necessary to do so.

FIG. 1B depicts, in cross-sectional view, aspects of an example of a device 100b. The device 100b includes a substrate 110b that has a substantially planar surface 115b on which is formed a number of first electrodes 120b, e.g., three or more electrodes. The device 100b also includes an overlayer 130b disposed on the substrate 110b such that the overlayer 130b in combination with the substantially planar surface 115b define a channel 101b (which extends into and/or out of the plane of FIG. 1B). A number of second electrodes 125b are also formed to follow the interior surfaces of the channel 101b that are defined by the overlayer 130b such that the second electrodes 125b, in combination with the first electrodes 120b, completely surround the channel 101b. The electrodes 120b, 125b are disposed on the substrate 110b/within the overlayer 130b such that they are separated from each other along the long axis of the channel 101b (i.e., into and/or out of the plane of FIG. 1B). also included are insulating layers 140b, 145b that separate the respective sets of electrodes 120b, 125b from the electrolyte disposed in the channel 101b.

The overlayer 130b of such a device could be formed in-place on the substrate 110b via semiconductor fabrication processes, rather than as a separate element that is later disposed on the substrate 110b. This could be beneficial, e.g., in order to reduce the need for an alignment step between the overlayer and the electrodes on the substrate. Such an overlayer 130b could be formed by first forming a sacrificial ridge of material whose location and geometry correspond to the location and geometry of the channel 101b to be formed (e.g., a layer of germanium or some other sacrificial material could be formed on the substrate 110b and then patterned to correspond to the desired location, shape, and size of the channel 101b). The overlayer 130b and optionally additional structures (e.g., the insulation layer 145b, the second electrodes 125b) could then be formed over the sacrificial material (e.g., by sputtering, PVD, CVD, e-beam deposition, etc.). For example, the overlayer 130b could be formed by depositing a layer of alumina or of some other compatible material on the substrate 110b and the sacrificial material. Once the overlayer 130b and optional additional elements are formed, the sacrificial material can then be removed (e.g., by a selective chemical etch).

Note that a device as described herein could have more than three electrodes arranged along a channel in order to facilitate manipulation of charged biomolecules. This could be done, e.g., to allow a single channel to store multiple samples of DNA (e.g., of the same DNA, or different DNA) at respective different locations along the channel. The voltages of the electrodes could then be controlled to facilitate movement of the samples along the channel, e.g., to combine the samples, the sequentially expel the samples from the channel, etc. Such manipulations could also include operations outside the context of using such a channel to store DNA for later expulsion/readout, e.g., to ‘pump’ DNA or other charged biomolecules from one location to another without electrolyte flow, to ‘gate’ the movement of DNA between regions of a microfluidic system (e.g., by applying a negative charge to prevent the DNA from passing from a first region through a first channel while allowing DNA from the first region to pass through a second channel by applying no voltage, or a positive voltage, to one or more electrodes thereof).

Additionally, while mention is made throughout to a variety of applications, operations, and embodiments in relation to DNA, it is intended that these references are intended as non-limiting example embodiments. Reference the ‘DNA’ throughout may be replaced, mutatis mutandis, with any alternative charged biomolecule of interest (e.g., RNA, polypeptides, synthetic sequences of biomolecules). For example, if the biomolecule of interest is positively charged, references to voltages herein can be correspondingly reversed, to account for the negative charge of DNA.

These as well as other aspects, advantages, and alternatives will become apparent to those of ordinary skill in the art by reading the detailed description with reference where appropriate to the accompanying drawings. Further, it should be understood that the description provided in this section and elsewhere in this document is intended to illustrate the claimed subject matter by way of example and not by way of limitation.

### II. EXAMPLE EMBODIMENTS AND EXPERIMENTAL DATA

With the rapid proliferation of data, there has been a tremendous drive to improve state-of-the-art data storage devices such as HDD-, SSD- and RAM-based technologies in terms of latency, power consumption, and storage density. Macromolecular data storage, such as DNA-based digital data storage, has emerged as a promising means to achieve new forms of ultradense storage devices. To accomplish these aims, embodiments herein facilitate DNA-based storage via precisely controlled and automated on-chip platforms that exhibit controlled random access and rewriting and that exhibit high durability and appropriate error control. Three major electrokinetic phenomena, namely, electrophoresis, di-electrophoresis (DEP), and electroosmosis, are the basis of micro/nanoparticle manipulation in aqueous solutions as described herein. DEP is applicable to both charged and neutral particles and can be useful to distinguish such particles in either uniform or nonuniform electric fields. Electrophoresis uses an external electric field and can be used to measure the motion of charged particles relative to the liquid medium in which they are suspended. Electroosmosis describes the motion of a liquid that contains a net charge. Embodiments described herein include generation of electrophoretic flux inside a microtube to manipulate charged particles (e.g., particles that includes DNA, which may have encoded therein information of interest).

There are several advantages of using electric fields for the on-chip manipulation of charged particles. Many parameters, including the magnitude and frequency of the signal, electrode distance, and electrode geometry, can be tuned to precisely control the field force exerted on the particles, which can help dictate the position of particles relative to electrodes or other particles in the system. Another advantage of using an electric field relates to the ease of fabricating planar or 3D microelectrodes on chip, in a manner compatible with other related fabrication processes (e.g., generation or incorporation of microfluidic elements/systems with the chip substrate, formation of addressing gates, voltage/current courses, DNA writing and/or readout electronics in the same chip as the electrodes). Embodiments described herein include the use of 3D circular electrodes and/or planar electrodes energized by DC voltage to manipulate and assemble particles on chip instead of or in addition to relying on spontaneous fluid flow (microfiltration or inertial microfluidics), optical traps, or chemical modifications.

Strain-induced self-rolled-up membranes (S-RuM) are an excellent option for various on-chip and off-chip applications in electronics, optics, materials science, biology, and micro/nanofluidics. S-RuM tubes are formed by the spontaneous deformation of stressed thin films driven by the relaxation of strain energy. Membranes made of material combinations such as semiconductors, oxides, nitrides, metals, polymers, and other hybrid thin films can be rolled up into micro- or nanotubes. The membranes can be strain engineered to precisely control tube diameter, tube length, number of turns and even tube orientation with high fabrication yields. Such a tubular structure provides several advantages. First, it provides a compact microfluidic chamber that can be modified for specific applications. The chamber can be made transparent for better optical imaging, integrated with electrodes for sensing and electrokinetics, or mechanically transformed to yield structures suitable for self-assembly and storage. Second, the tubular/cylindrical nature of the cuffed-in electrodes can provide a more uniform electric field, resulting in improved sensitivity and throughput. Third, planar processing techniques used for fabricating these on-chip tubular devices are scalable to the industrial level and can be fabricated on a wide variety of substrates. Wafer-scale integration of these microtubular devices with multiple channels on chip can realize successful commercialization for more sophisticated needs in the field of flexible bioelectronics. Moreover, once rolled, the footprint of the tubes can also be used for placing other microfluidic chambers on chip for integration purposes.

Additionally or alternatively, such channels for storage and/or manipulation of charged biomolecules (e.g., DNA) can be implemented in a more planar configuration, with electrodes formed on a substantially planar surface of a chip or other substrate. A channel is then formed by disposing an overlayer on the substrate that, in combination with at least a portion of the substantially planar surface of a chip, defines the channel such that the electrodes are separated from each other along a long axis of the channel. This allows respective voltages to be applied to the electrodes, as described elsewhere herein, in order to selectively collect DNA or other charged biomolecules into the channel, to retain such biomolecules in the channel, and/or to expel such biomolecules from the channel in order to provide some desired functionality (e.g., selective storage and release of DNA or other biomolecules having stored therein desired information). Formation of such an overlayer can be accomplished in a variety of ways, e.g., by adhering a PDMS or other polymeric element to the substrate, by forming the overlayer over a sacrificial ridge that defines the geometry of the channel and later etching or dissolving away the sacrificial material, etc.

Embodiments of the present disclosure include integrating the S-RuM platform or other channel-containing device having electrodes with an electrical circuit (e.g., an externally operated circuit and/or a circuit incorporated into the substrate on which are formed the channels) to control and manipulate charged particles, e.g., DNA. In some embodiments, channel lengths may be fabricated to be compatible with the size of the species to be manipulated so that the inherent charge on the species can be successfully accelerated (repelled/attracted) inside the channel. The driving potentials applied to the electrodes and the channel sizes and geometry can be adapted to the specifics of the biomolecule to be manipulated, the electrolyte containing the biomolecule, the specifics of the application (e.g., a desired rate of collection/retention/expulsion cycles), or other factors. Embodiments of the present disclosure implement a set of example electrophoretic/electroosmotic control structures fabricated on chip using S-RuM technology and using standard MEMS processing.

On-chip manipulation of charged particles using electrophoresis or electroosmosis is used for many applications, including optofluidic sensing, bioanalysis, and macromolecular data storage. Embodiments of the present disclosure include a technique for the capture, localization, and release of charged particles and DNA or other negatively or positively charged biomolecules in an aqueous solution using channels in proximity to electrodes. Such electrode-associated channels can include tubular structures enabled by a strain-induced self-rolled-up nanomembrane (e.g., S-RuM) platform. Cuffed-in 3D electrodes that are embedded in cylindrical S-RuM structures and biased by a constant DC voltage may be used to provide a uniform electrical field inside the microtubular devices. Efficient charged-particle manipulation may be achieved at a bias voltage of <2-4 V, which is ˜3 orders of magnitude lower than the required potential in traditional DC electrophoretic devices. Furthermore, Poisson—Boltzmann equation simulation validates the feasibility and advantage of such microtubular channel charge manipulation devices for planar electrode/channel geometries and other 3D variations of microfluidic devices. This work facilitates on-chip DNA (or other large, charged biomolecule) manipulation for data storage applications.

Strain-Engineered Self-Rolled-Up Membrane Device

An array of microtubes (S-RuM) were fabricated on chip via two-dimensional planar processing lithography. Metallic (Au) electrodes were deposited on the strain-engineered AlN membranes, which were then released from the substrate to roll-up and create a cuffed-in tubular electrode architecture. To simplify optical characterization, a semitransparent mixed phase (C to M) of sapphire substrates was chosen; note that alternative, non-transparent insulating substrates such as glass or SOI substrates are also possible.

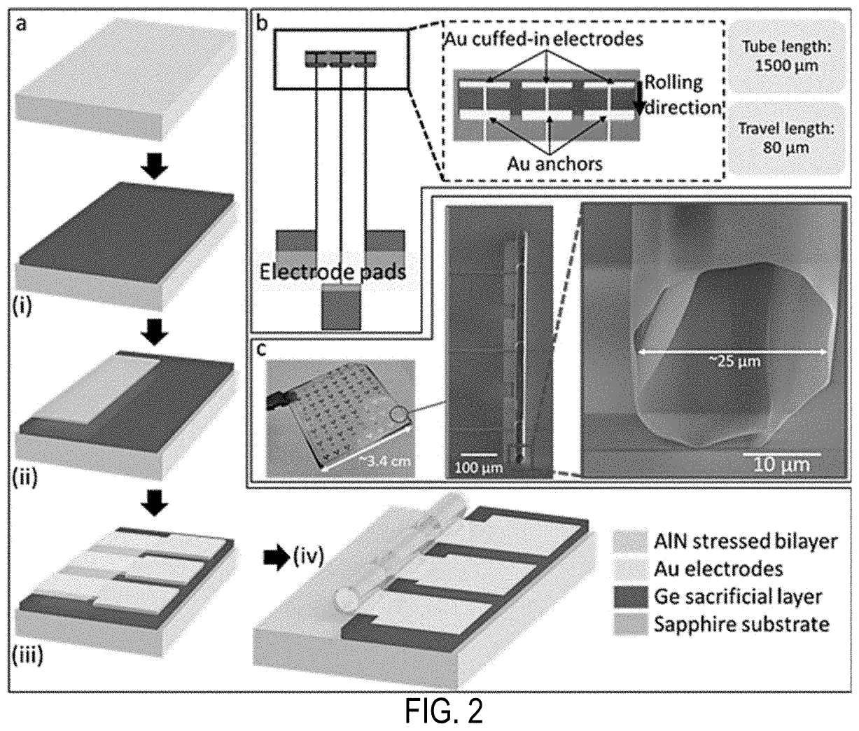

The process steps for S-RuM fabrication are depicted in pane ‘a’ of FIG. 2 and are also described in additional detail below. Steps included in the fabrication of an example microtube device, as illustrated in pane ‘a’ of FIG. 2, include: (1) e-beam evaporation of a sacrificial Ge layer blanket on a transparent sapphire substrate, (2) an AlN stressed bilayer is then sputtered and patterned using photolithography, (3) e-beam evaporation of Au electrodes and then patterning to the desired 2D geometry, (4) selective gas-phase etching of the Ge sacrificial layer to yield the 3D S-RuM microtube device. Pane ‘b’ of FIG. 2 illustrated a schematic of the ‘unrolled’ device showing electrode pads. The image to the right in pane ‘b’ of FIG. 2 shows the 2D geometry of Au electrodes that will be cuffed-in once they are rolled-up. The total length of the tube is 1500 μm and the ‘travel’ length (gap between electrodes) is 80 μm. Pane ‘c’ of FIG. 2 shows optical images of an array of microtube devices on a chip. On the right side, zoomed-in SEM images of the microtube at a tilted angle depict the diameter (˜25 μm) and roughly ‘circular’ nature of the tube

The Au electrodes are patterned so that they not only provide improved voltage control and uniformity but also so as to reduce interference with optical characterization of the devices. The axial configuration of electrodes enables a better definition and control of the electric field inside the microtubular channel compared to some alternative 3D (pillar- or sidewall-patterned electrodes) versions of the electrodes. The illustrated 2D geometry (I-shaped) of the electrodes was chosen to minimize interference by the electrodes during optical measurements/imaging of inflow micro/nanoparticles. Increased control and uniformity can be achieved by rolling more complex 2D geometries, such as interdigitated electrodes. Upon entry, microparticles (e.g., strands or clumps of DNA) experience turbulence due to capillary forces that can interfere with e-field control of microparticle location. Thus, the spacing between the electrodes (80 μm) and tube length (1500 μm) were selected to reduce such effects and to facilitate observation of fully developed flows. The spacing between the electrodes is labeled as the ‘travel length’ since it is the longitudinal distance the charged species inside the microtube travels under the effect of an e-field. The ‘internal’ nature of the electrode facilitates DEP manipulation, and the three electrode structure (left, middle, and right) shown serves as a proof-of-concept device for charged species manipulation. There is no practical limitation on integrating more electrode feed lines inside the microtube, nor are the embodiments herein limited to electrical manipulation of charged particles via electrophoresis.

The AlN-stressed bilayers were strain engineered to result in a specific 3D geometry of the microtube. The bilayer thickness (60 nm), cumulative stress (+400 MPa tensile membrane on top of a −1200 MPa compressive membrane) and patterned 2D geometry of the membrane were carefully controlled to yield tubes with a diameter of ˜25 μm with −1.5 turns (pane ‘c’ of FIG. 2). To further improve the yield and e-field strength of the microtubular devices, the area of electrodes that lies outside the microtube was isolated using a thin (10 nm) alumina passivating layer. Thus, only the electrode area inside the microtube is in direct contact with the fluid of interest.

The overall 3D geometry of the S-RuM device, material properties of the constituents and axial nature of the electrodes all affect the sensitivity with which charged species can be manipulated to move inside the channel. The effect of the e-field on the particle position and velocity are demonstrated in detail below using a polystyrene microsphere solution.

For the purpose of deterministically pumping and controlling the solution feed, it is possible that the S-RuM for other channel platforms be incorporated into a micro/nanofluidic circuit. The integration has three elements: fabrication of micro/nanofluidic channels on a soft polymeric material such as polydimethylsiloxane (PDMS), aligning channels to the on-chip circuit and bonding the PDMS to the substrate to air seal the channels (prevent leakage). Photolithography was used to position the microtubes on the chip, thereby enabling encapsulation in PDMS-based microfluidics to serve as an integrated device.

Particle Dynamics and Device Functionality

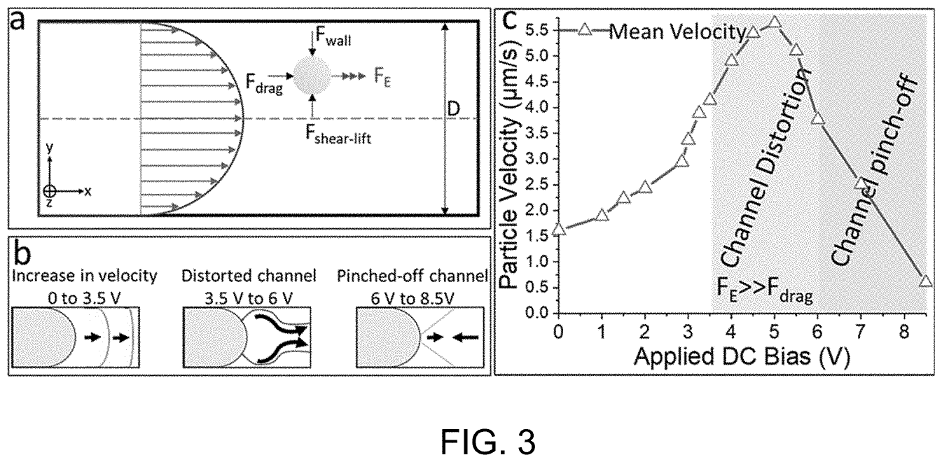

Pane ‘a’ of FIG. 3 depicts a schematic illustration of a section of the microtube (diameter, D) with a microparticle experiencing F_{wall} (repulsion force from tube wall), F_{shear-lift} (shear gradient lift force), F_{drag} (viscous drag force), and the external F_{E} (electrostatic force) responsible for particle position and velocity inside the microtube. Pane ‘b’ of FIG. 3 depicts schematic illustrations (left to right) showing behavior of particles between the electrodes inside the microtube. From 0 to 3.5 V, the velocity increases until the velocity profile becomes more uniform. From 3.5 V onwards, the channel begins to distort and then finally pinch-off is reached where particle-particle repulsion interferes with F_{E}. pane ‘c’ of FIG. 3 shows the change in mean velocity of the particles with applied bias (0 to 3.5 V). Beyond 3.5 V the flow channel inside the microtube starts to distort and particles experience turbulence. Pinch-off condition is met when particles can no longer cover the distance between electrodes due to particle-particle repulsion resulting from accumulated charged particles at the target electrode.

Inside the microtubular channel, in addition to the viscous drag force (F_{drag}) in the axial direction, the particles also experience two opposing transverse forces (the wall repulsion force (F_{wall}) and shear-gradient lift force (F_{shear-lift})). Along the longitudinal direction of the microtube, the particles thus experience both axial and lateral forces compelling them to migrate toward equilibrium locations (pane ‘a’ of FIG. 3). For charged or polarizable particles (e.g., DNA), an additional external electrostatic force (F_{E}) can be used to manipulate their position and velocity inside the channel. If a direct current (DC) field is applied tangential to the surface of the channel, a free particle within the electric double layer (EDL) will respond to the field and move toward the counter electrode. However, the EDL thickness in most channels carrying buffer solutions is much smaller than the characteristic lengths of typical microfluidic channels. Thus, an electric field-mediated microtubular device enables more uniform linear electrokinetic motion inside the tubular channel (across the cross-section) by converting the supplied electric energy into kinetic energy for the microparticles. DC electric fields can be used to drive both fluid electroosmosis and particle electrophoresis inside microchannels; thus, particle manipulation in this electrophoretic manipulation study does not require hydrodynamic pumping of the particulate solution. A micropump was used to control the feeding of the particulate (1 μm polystyrene spheres) solution inside the tube. The average velocity was then used to quantify the movement of charged particles inside the three electrode microtubes with respect to the applied bias. One end (left) of the microtube was loaded with a small volume of particulate solution until capillary action filled the entire tube. A specific mixture was prepared to ensure that the solution did not prematurely dry out while also helping to reduce electrochemical effects on the electrode surface. Far from the point of entry, the microparticles were then allowed to stabilize before biasing the middle electrode and right-most electrode. The polystyrene spheres used in this study had an inherent negative zeta potential and thus traveled toward the positive terminal. Panes ‘b’ and ‘c’ of FIG. 3 depicts a proportional response with increasing mean velocity as the applied bias is increased (up to 3.5 V). As expected, the particles accelerated, and the mean velocity in the channel increased with an increasing e-field. From 3.5 V onward, the off-center particles experience increased electrical lift force, and the channel started to distort. For particles in and around the channel axis, the e-field was symmetric along both the axial and transverse directions. However, for the off-center particles, e-field line distributions in the transverse directions became asymmetric. This asymmetricity resulted in a wall-induced electrical lift force causing the particles to drift away from the walls. Moving from the center to the channel wall, this wall-induced electrical lift (channel distortion) became more pronounced with increasing DC field. Beyond 6 V, the excessive accumulation of negatively charged microspheres on the counter electrode countered the electrostatic force; thus, the channel was slowly pinched off as the average velocity of the particles diminished. Inside a cylindrical channel, and sufficiently far from the point of entry, the radial velocity (V(r)) profile in a fully developed steady flow takes a parabolic form and can be described by the Hagen-Poiseuille equation:

$$V ( r ) = 2 {V}_{m} ( 1 - {( \frac{r}{R} )}^{2} )$$

where Vₘ is the mean velocity (calculated as 1.614 μm/s), r is the radial position from the center and R is the radius of the tube.

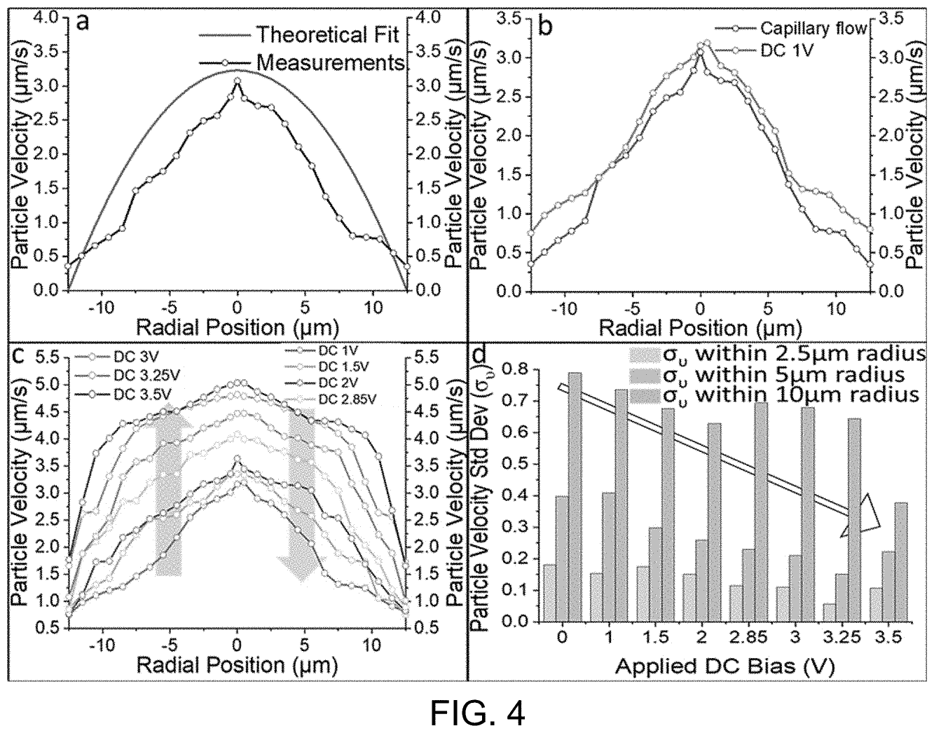

The data in FIG. 4 are the result of tracking multiple particles over different frames, time intervals and under different bias conditions. For the purpose of making accurate measurements, the focal plane of interest was aligned to an imaging system. Pane ‘a’ of FIG. 4 depicts theoretical and experimental comparisons of the fully developed velocity profile of the microparticles inside the microtube (radial position) due to the viscous drag force (F_{V}). Pane ‘b’ of FIG. 4 depicts the change in velocity profile (net increase in particle velocity) under the influence of external electrostatic force (F_{E}). Pane ‘c’ of FIG. 4 depicts particle velocity as a function of applied bias. The blue arrow depicts the direction of increasing magnitude of the applied bias and the orange arrow depicts the direction of electric field inside the microtube. As the voltage is gradually increased, the velocity profile is flattened. This is depicted in pane ‘d’ of FIG. 4, as evident from the downward trend (hollow black arrow) in standard deviation of particle velocity with respect to increasing bias. Moving further away from the center the difference is more noticeable due to edge effects.

Pane ‘a’ of FIG. 4 shows the comparison between the theoretical and experimental microparticle velocity profiles inside the 25 μm-diameter microtubular device under zero bias conditions. Applying a DC bias of 1 V increases the mean microparticle velocity; however, the velocity profile is still nonuniform with respect to the radial position, as shown in pane ‘b’ of FIG. 4. As the applied bias is gradually increased, the turbulency in the flow increases, and the particle velocity profiles become much more uniform over most of the flow (pane ‘c’ of FIG. 4). A much sharper change in velocity is observed near the boundary because of the no-slip condition on the channel walls. In a geometrically nonuniform microchannel, the breakdown in e-field symmetry can lead to di-electrophoretic particle motion effects when exposed to a DC electric field, and the influence of the insulating channel wall can be significantly difficult to curb. Most traditional microfluidic channels are rectangular, and these edge effects become more prominent as the particles move in transverse directions. Therefore, the axial and tubular nature of the electrodes inside a circular cross-section channel can reduce such effects and lead to more uniform fluid fronts. As shown in pane ‘d’ of FIG. 4, in the vicinity of a radius of up to at least 5 μm, the standard deviation in particle velocity gradually decreases until an improved e-field condition is reached. Deviations from traditional electrokinetic phenomena can also be understood by examining the effects of the e-field on the electrophoretic mobility of the PSB microspheres (1 μm). Additionally, 200 nm polystyrene latex spheres were used to demonstrate bulk manipulation.

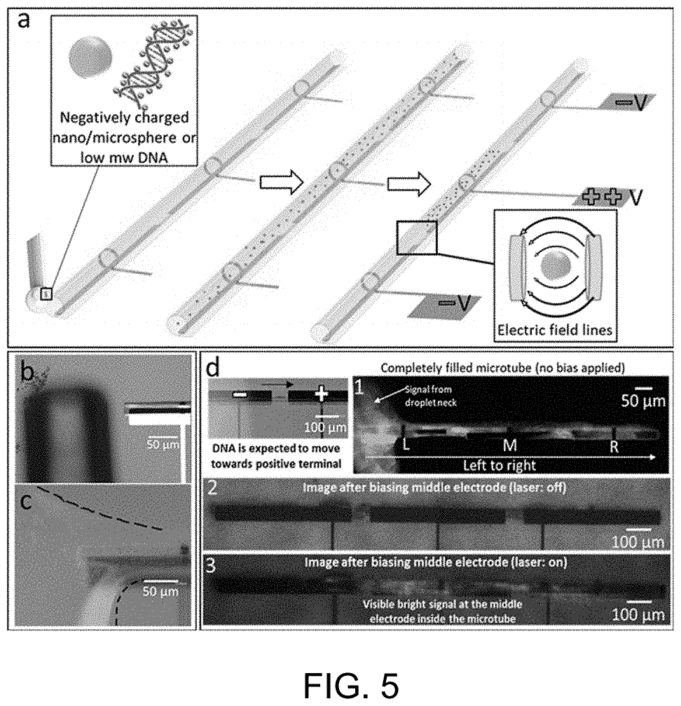

Large-scale macromolecular (e.g., DNA, RNA) data storage may rely heavily on laborious manual pipetting of DNA solutions for synthesis and microanalysis. An automated lab-on-a-chip (LOC) platform as described herein would contribute significantly to industrial-level scalability for DNA- or other charged biomolecule-based digital data storage. The use of electrophoresis to drive the sequential capture, holding, and release of DNA molecules on chips can be facilitated by the integration of electric field-mediated trapping devices like those described herein. Given the diameter of DNA (˜2 nm), such devices could include compatible channel sizes, integrated electrodes, and uniform e-fields for the precise control of DNA movement inside the channel(s). The data provided herein demonstrates the utility of manipulating charged species inside a closed tubular structure, and as shown in FIG. 5, the embodiments described herein can be used to trap low molecular weight (mw) DNA (or other negatively or positively charged biomolecules of interest) inside a microtube by appropriately biasing the cuffed-in electrodes.

Pane ‘a’ of FIG. 5 includes a 3D schematic that depicts filling a tubular device with species containing charge particles (nano/microspheres and DNA on the present example). On the right of pane ‘a’, capillary action fills the tube uniformly with charged species; subsequently, and a low-magnitude positive voltage was applied on the middle electrode and low-magnitude negative voltages applied on the outer electrodes (rightmost aspect of pane ‘a’) to capture and hold the charged species inside the tube. Pane ‘b’ of FIG. 5 includes an optical image depicting the micro syringe needle placed near the channel end in order to dispense fluids. Pane ‘c’ of FIG. 5 includes an optical image showing the capillary neck formed at the tube opening after dispensing the fluid. Pane ‘d’ of FIG. 5 depicts how a low-magnitude potential difference of ˜2V (relative to a ‘ground’ potential of the electrolyte solution within the channel) is sufficient to move DNA from the left to the middle electrode. Labelled 1, 2 and 3 within pane ‘d’ are fluorescent microscopy images serving as proof of concept for localizing DNA toward the middle electrode by appropriately biasing the electrodes.

The strategic loading and DNA capture mechanisms are depicted in pane ‘a’ of FIG. 5. The low mw-labeled DNA used in the study depicted herein has a net negative charge and can be located optically using laser excited fluorescent microscopy. A more positive voltage can thus be applied on the middle electrode to drive, capture, and concentrate DNA in the center of the tube. The tubular electrode geometry provides uniform field lines between the parallel electrodes that facilitate holding DNA inside the channel. The optical and fluorescence microscopy images in panes ‘b’-′d′ of FIG. 5 highlight the artifacts associated with DNA loading, manipulation, and detection, respectively. A 3D platform such as S-RuM built on 2D planar processing can be optimized to provide a much more uniform electric field and thus better manipulate DNA inside integrated electronic devices with nano- or microscale resolution. Dynamic simulations were performed to analyze microfluidic devices carrying DNA buffer solutions and to compare e-field profiles inside a tubular design (such as S-RuM) and alternative planar (e.g., rectangular cross-section) counterparts.

Validation Using Multiphysics Simulations

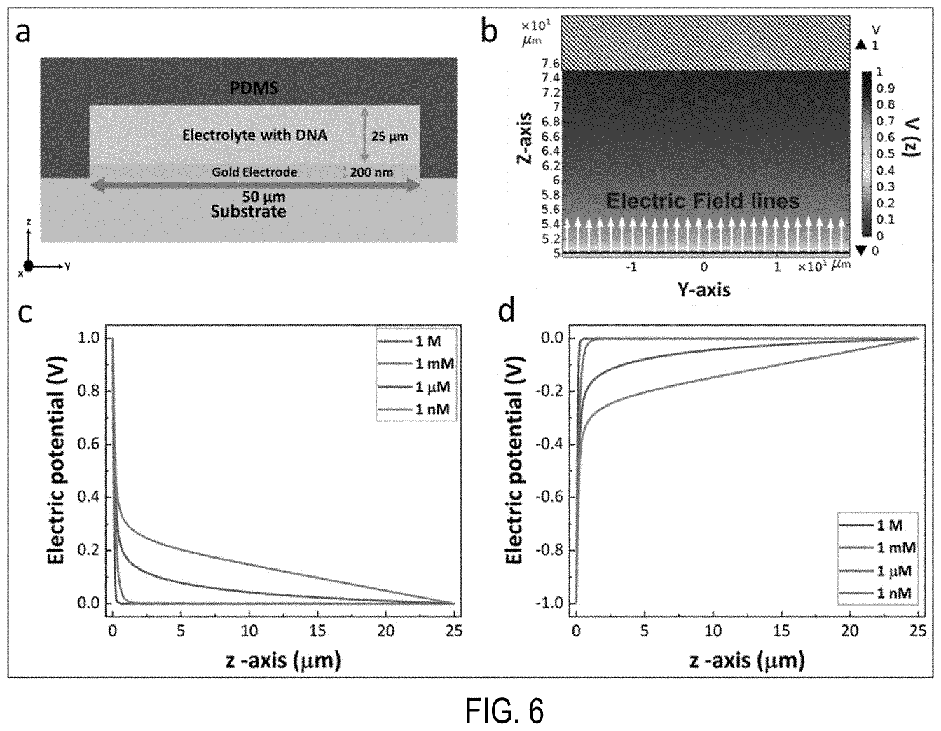

To effectively manipulate the flow of DNA under the influence of DC-biased electrodes, the electrolyte screening length (or Debye length), which is inversely proportional to the square root of the electrolyte concentration, can be specified. The sizes of the channels carrying the DNA strands can be specified along with the electrolyte concentration to reduce leakage of DNA strands from the channels when the channel electrodes are appropriately biased to retain the DNA within the channel. The device structure with planar electrodes was simulated, as depicted in pane ‘a’ of FIG. 6 which shows a cross-section of a planar-type channel device in the z-y plane. The structure includes a 50 μm×100 μm alumina substrate onto which a 200 nm×25 μm gold electrode was deposited. This setup was encapsulated with polydimethylsiloxane (PDMS) overlayer, leaving a channel height of 25 μm and a channel width of 50 μm. COMSOL Multiphysics simulations coupled the continuity equation for the concentration of ion species in the electrolyte with Poisson's equation in order to obtain the electrostatic potential inside the channels (as shown in pane ‘b’ of FIG. 6 for 1 nM KCl solutions under 1 V bias). The electric field lines point upward inside the tunnel.

Panes ‘c’ and ‘d’ of FIG. 6 show the electrostatic potential profiles inside the channel with applied voltage biases of 1 V and −1 V, respectively, and for electrolyte concentrations inside the tunnels varying from 1M to 1 nM. Here, a steep drop in the potential across the electrode surface is observed followed by an exponential decrease from the electrode-electrolyte interface to the far face of the channel. For 1M KCl, the potential drops down to 0 V within a few nanometers from the interface. However, the electric potential at the far side (z=25 μm) of the channel decreases to 0 V, which creates a path for the chimeric DNA strands to escape from the tunnel at the depicted bias voltage levels, indicating that greater bias voltages (e.g., less than 2 volts, relative to a ‘ground’ potential of the electrolyte) are necessary to prevent DNA strand escape from the tunnel.

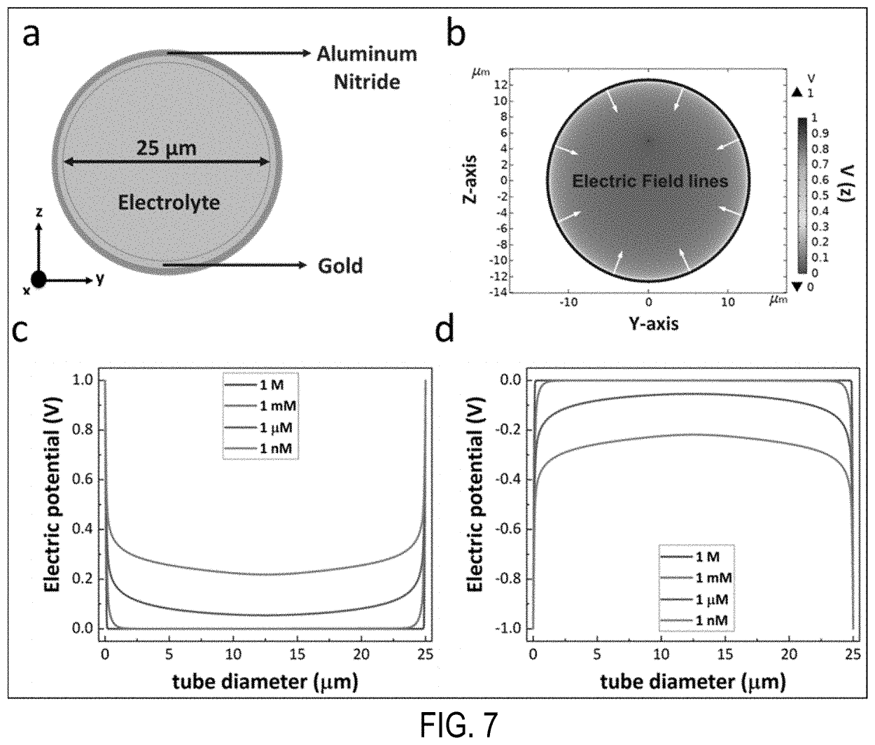

An encouraging solution to the problem is to use a closed device design, such as a tubular structure where electrodes cover all walls of the tunnels, resulting in a uniform radial electric field inside the channel, as depicted in pane ‘a’ of FIG. 7, which depicts a cross-section of a rolled tube-type channel, with cuffed gold electrodes on rolled-up AlN tubes, in the z-y plane. Pane ‘b’ of FIG. 7 shows the electrostatic potential inside such a channel, with 1 nM KCl solutions under 1 V bias. The electric field lines point inwards inside the tube, creating a uniform and concentrated potential.

Panes ‘c’ and ‘d’ of FIG. 7 show the electrostatic profile inside the tube for applied voltage biases of 1 V and −1 V, respectively, with different electrolytic concentrations inside the tube. The electric potentials with lower electrolyte concentrations, such as 1 μM and 1 nM, remain at ˜±100 mV and ˜±300 mV, respectively, at the center of the tube. This demonstrates that the motion of biomolecules, such as DNA, can be effectively controlled by the voltage applied to the cuffed electrodes in the S-RuM device structures.

Example embodiments of the present disclosure include a versatile on-chip technique for controlling the particles in microchannels with a 3D electric field. The highly scalable and compatible planar processing techniques described herein can be used to incorporate different materials while also optimizing the tubular geometry to accommodate numerous applications in the field of micro/nanofluidics. The compact structure not only provides precise fluid control but also reduces sample consumption; additionally, the strong confinement effects enable efficient particle manipulation. Lower voltages (<2-4 V) can be used to generate a much higher e-field (>104 V/m) between the electrodes. This lowers the power consumption and reduces the Joule heating effect that is dominant in other designs of 3D electrophoretic devices that have operating voltages as large as >103 volts. The designs described herein can be adapted for DEP-based manipulation techniques that could employ an even lower peak-to-peak working voltage. Successful encapsulation of S-RuM devices and/or planar (e.g., rectangular) channel devices with traditional microfluidics can facilitate integration with commercially available automated DNA sequencing nanopore technology. Once integrated into LOC systems, such electrokinetic manipulations of charged species can result in easy operation and reconfiguration for application in numerous other technologies, such as point-of-care applications.

AlN Microtube Fabrication with Cuffed-In Electrodes

The AlN microtubes were fabricated with an S-RuM fabrication technique. A 100 nm Ge layer was deposited on a mixed phase 4-inch sapphire wafer using e-beam evaporation (Kurt J. Lesker Metals E-Beam Evaporator). Then, the AlN stressed bilayer was deposited using RF magnetron reactive sputtering. Die-sized samples were cleaved and diced (FlipScribe 100, LatticeGear) from the four-inch wafers. Contact photolithography (AZ 5214E dual tone photoresist and Karl Suss MJB3 Contact Mask Aligner) was then used to pattern arrays of rectangular mesas defined using reactive ion etching (Oxford Mixed ICP-RIE). Subsequent negative lithography was used to lift off (AZ-917 MIF) 185 nm of cumulative Ti/Au metal deposited using e-beam evaporation. The metal also acted as an anchor for the microtubes. A thin (5 nm) conformal cover layer of Al₂O₃ was deposited using atomic layer deposition (Veeco NanoTech Atomic Layer Deposition tool) on top to facilitate the rolling process and maximize the yield. The exposed electrode area (area outside the tube) was also coated with a thin layer (10 nm) of ALD alumina. Another lithography step was performed to open the electrical contacts and etch windows on one end of the rectangular mesa to define the rolling front. The Ge underlayer was then selectively dry-etched (a Xactix XeF₂ etching system) using fluorine-based chemistry to release the membrane from the substrate, which eventually rolled up into a microtube with cuffed-in electrodes. The tube windings, tube diameter, and electrode area were engineered in a specific way to facilitate both capillary action and postprocessing fluorescent imaging.

Integration with Traditional Microfluidics

Standard soft lithography processes were used for the fabrication and encapsulation of microfluidic channels. A PDMS mixture of elastomeric polymer and crosslinking agent at a weight ratio of 10:1 was used to cast the channels. A master mold for PDMS molding was fabricated on a 2-inch Si wafer by patterning SU-8 negative photoresist (SU-8 25, MicroChem Corp., USA). The PDMS mixture was then poured on top of the mold followed by degassing (1.5 h) and curing (at 60° C. for 24 h). After curing, the PDMS was peeled off, and tubing connections were made by punching holes into channel ends located on PDMS. The sapphire substrate was then exposed to a vacuum ultraviolet (VUV) ozone environment (custom setup) to enhance bonding with PDMS. Finally, the PDMS slab was aligned using a Karl Suss MJB3 contact mask aligner. External elastic tubing connections were then made to test the device.

Polystyrene Solution Preparation

The 1 μm polystyrene beads (PSB) (Alfa Aesar) were ultrasonicated for 15 min prior to use. To assist in wetting the tubes and prevent the solution from drying, 1 volumetric part of PS bead solution (10 wt % suspension in water) was mixed with 8 parts deionized water (DI), 3 parts isopropyl alcohol (IPA), and 3 parts propylene glycol (PG) [8:3:3:1, DI:IPA:PG:PSB]. Additionally, a solution was prepared without IPA and propylene glycol (8:1, DI:PSB) to compare and contrast the effects of evaporation and electrochemical reaction on thee electrodes. In both cases, the dispensing solution was thoroughly shaken for 2 min prior to use. A 100 μl NanoFil syringe pump (World Precision Instruments UMP3) was used to automatically dispense the solutions (volume of 500 nl).

Charged Particle Manipulation and Fluorescent Imaging

For fluorescent beads, 200 nm polystyrene latex beads (Invitrogen) were used as received. For DNA imaging, a 10 ng/μL solution of a low molecular weight DNA ladder (25-766 bp, New England Biolabs) was stained at a 1:10 dye:base pair ratio using an intercalating nucleic acid dye (YOYO-1, Invitrogen) in 1X TAE buffer comprised of 40 mM Tris (pH 7.6), 20 mM acetic acid, and 1 mM EDTA. The concentration of DNA was checked via a UV-Vis spectrophotometer (Nanodrop) prior to dilution to the desired concentration. The solution containing DNA and YOYO-1 was incubated in the dark for at least 2 h prior to imaging.

The bead solution was diluted to ⅛th of the as received concentration (2 wt %). The diluted nanobead solution/DNA-containing solution was drop-cast on one end of the microtube, and sufficient time was given to let capillary action take place and the liquid stabilize/settle inside the tube. Note that the outside of the tube also had a considerable amount of liquid sticking to the tube surface due to surface tension and static charge effects. Then, a constant DC voltage was applied on the right-most electrode pad in reference to the left-most electrode to induce charge particle/DNA movement. The potential was kept constant until the liquid dried off. The 2D mask designs for the cuffed-in electrodes were designed so that when the tube was flipped, the electrodes did not interfere with imaging.

Epi-illumination of the fluorescent beads and labeled DNA was achieved using an inverted microscope (Olympus IX71) equipped with a 488 nm, 50 mW continuous wave (CW) laser (Excelsior-488, Spectra Physics). The incident beam was passed through a 488 nm longpass beamsplitter (Chroma), and the emitted light was filtered through a 525/50 nm bandpass filter (Semrock), where it was captured by an electron-multiplying charge-coupled device (EMCCD, Andor) camera. A 10×0.25 NA objective (Olympus) was used, resulting in an overall pixel size of 1.6 μm.

Particle Velocity Measurements

An ultrazoom optical microscope (Keyence VHX 7000 series) was used with a partial ring illumination filter to capture 2048×1536 pixel (resolution) videos at 15 fps. The RGB coded videos were analyzed using open-source image analysis software (ImageJ). A TrackMate-ImageJ extension was used to track more than 30 particles across the traveling length (electrode gap) under different biasing conditions. The initial and final positional coordinates of the particles were extracted for different focal planes (radial position) across a depth of 25 μm (tube diameter). The extracted pixel coordinates of the particles were used to calculate the distance traveled across a span of 5 to 6 seconds (77 or 92 frames, respectively).

Use of COMSOL Multiphysics

Simulations were performed using COMSOL Multiphysics software, combining the transport of diluted species with electrostatic physics to account for mass transfer and charge transfer. One of the simplest physical models of a double layer is the Gouy-Chapman-Stern (GCS) model, where the diffuse double layer is treated as a multiphysics coupling of the Nernst-Planck equations for the mass transport of all ions, with the Poisson equation (Gauss's law) being used for the charge density and electric field. The combination of these equations, referred to as the Poisson-Nernst Planck (PNP) equations or Nernst-Planck-Poisson (NPP) equations, was used to solve for the potentials induced by the electrodes inside the channels.

COMSOL finite element modeling software was used to simulate electrically controlled nanofluidic devices with two-dimensional (2D) geometry. The fluxes of electrolytic ions, Ji, in the nanofluidic channel were modeled using the Nernst-Plank equation, as described in Eq. 1:

$${J}_{i} = - {D}_{i} ∇ {c}_{i} - {u}_{m , i} {z}_{i} {F}_{{c}_{i}} ∇ ϕ [ SI Unit : \frac{m o l}{{m}^{2} \cdot s} ]$$

where Dᵢ is the diffusion coefficient of the ion species i, cᵢ is the concentration of the polar ions in the electrolyte (i=+ or − with zᵢ=+1 or −1 charge, respectively), u_{m,1} the mobility, F is the Faraday constant, and ϕ is the electric potential obtained from Poisson's equation (Eq. 2):

∇·(−ε∇ϕ)=ρ[SI Unit: V]

where ε is the relative permittivity and ρ is the charge density, which depends on the ion concentration, p=F(c₊−c₋).

The outer boundaries of the devices were set to ground conditions in which ϕ=0. The ion concentrations were set to their bulk values, which were electroneutral. Additionally, it was assumed that there were no ion reactions in the electrolyte. Hence, the conservation of mass for both ion species required that ∇·Jᵢ=0.

To implement the Stern theory of double-layer formation, a boundary condition for the electrolyte potential at the electrode interface was imposed having a constant Stern layer thickness, As, as described in Equation 3:

ϕ+λ_{S}(n·∇ϕ)=ϕ_{M}

where n is the unit vector normal to the electrode surface and ϕ_{M} is the potential applied to the electrode.

### III. EXAMPLE METHODS

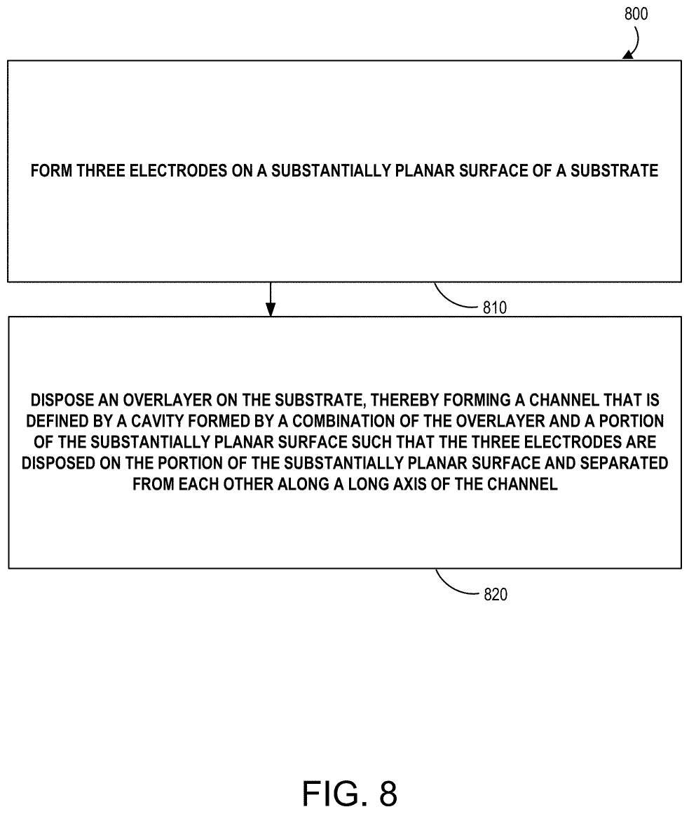

FIG. 8 depicts an example method 800. The method 800 includes forming three electrodes on a substantially planar surface of a substrate (810). The method 800 additionally includes disposing an overlayer on the substrate, thereby forming a channel that is defined by a cavity formed by a combination of the overlayer and a portion of the substantially planar surface such that the three electrodes are disposed on the portion of the substantially planar surface and separated from each other along a long axis of the channel (820). The method 800 could include additional steps or features.

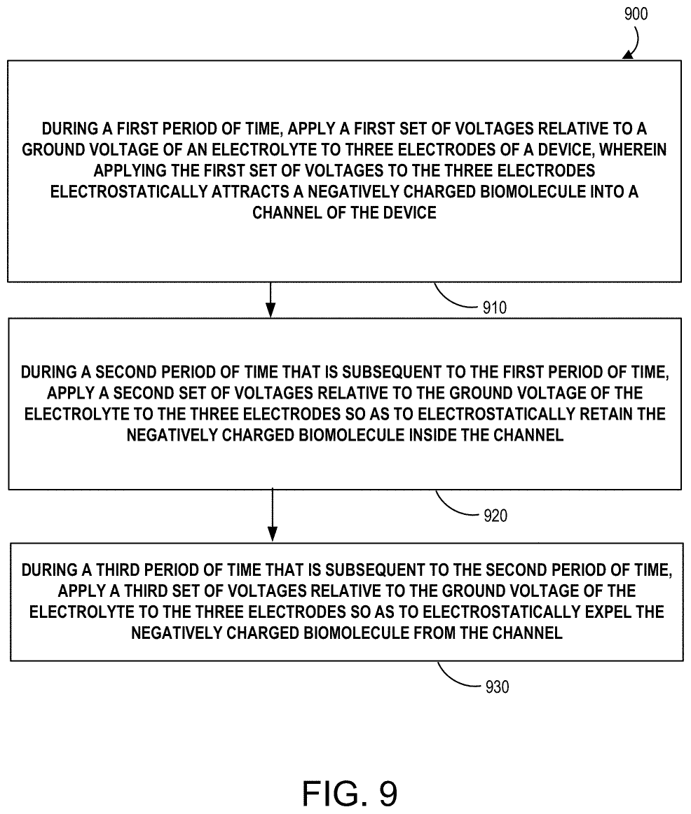

FIG. 9 depicts an example method 900. The method 900 includes, during a first period of time, applying a first set of voltages relative to a ground potential of an electrolyte to three electrodes of a device, wherein applying the first set of voltages to the three electrodes electrostatically attracts a negatively charged biomolecule into a channel of the device (910). The device additionally includes: (i) a substrate having a substantially planar surface, wherein the three electrodes are disposed on the substrate, and (ii) an overlayer disposed on the substrate, wherein the overlayer, in combination with a portion of the substantially planar surface forms a cavity that defines the channel that contains the electrolyte, wherein the three electrodes are disposed on the portion of the substantially planar surface and separated from each other along a long axis of the channel, wherein an electrolyte is disposed within the channel. The method 900 additionally includes, during a second period of time that is subsequent to the first period of time, applying a second set of voltages relative to the ground potential of the electrolyte to the three electrodes so as to electrostatically retain the negatively charged biomolecule inside the channel (920). The method 900 additionally includes, during a second period of time that is subsequent to the first period of time, applying a second set of voltages relative to the ground potential of the electrolyte to the three electrodes so as to electrostatically retain the negatively charged biomolecule inside the channel (930). The method 900 could include additional steps or features.

It should be understood that arrangements described herein are for purposes of example only. As such, those skilled in the art will appreciate that other arrangements and other elements (e.g., machines, interfaces, operations, orders, and groupings of operations, etc.) can be used instead of or in addition to the illustrated elements or arrangements.

### IV. CONCLUSION

It should be understood that arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

We claim:

1. A device comprising:
a substrate having a substantially planar surface;
three electrodes disposed on the substrate; and
an overlayer disposed on the substrate, wherein the overlayer, in combination with a portion of the substantially planar surface, forms a cavity that defines a channel, wherein the three electrodes are disposed on the portion of the substantially planar surface and separated from each other along a long axis of the channel.

2. The device of claim 1, wherein the three electrodes comprise gold.

3. The device of claim 1, further comprising an insulating layer disposed on the three electrodes, wherein the insulating layer comprises alumina.

4. The device of claim 1, wherein the overlayer comprises polydimethylsiloxane.

5. The device of claim 1, wherein the substrate comprises sapphire.

6. The device of claim 5, wherein the overlayer and substrate are optically transparent to at least one band of wavelengths of visible light, thereby allowing an interior of the channel to be optically interrogated from outside of the device.

7. The device of claim 1, further comprising at least one additional electrode disposed on the substrate, wherein the at least one additional electrode is disposed on the portion of the substantially planar surface and separated from the three electrodes along the long axis of the channel.

8. The device of claim 1, further comprising:
a controller that is operably coupled to the three electrodes, wherein the controller is configured to perform controller operations comprising:
during a first period of time, applying respective voltages relative to a ground potential of an electrolyte within the channel to the three electrodes so as to electrostatically attract a negatively charged biomolecule into the channel;
during a second period of time that is subsequent to the first period of time, applying respective voltages relative to the ground potential of the electrolyte to the three electrodes so as to electrostatically retain the negatively charged biomolecule inside the channel; and
during a third period of time that is subsequent to the second period of time, applying respective voltages relative to the ground potential of the electrolyte to the three electrodes so as to electrostatically expel the negatively charged biomolecule from the channel.

9. The device of claim 1, wherein the channel has a substantially rectangular cross-sectional geometry having a height above the substantially planar surface that is less than 110 microns.

10. A method comprising:
during a first period of time, applying a first set of voltages relative to a ground potential of an electrolyte to three electrodes of a device, wherein the device additionally comprises:
a substrate having a substantially planar surface, wherein the three electrodes are disposed on the substrate, and
an overlayer disposed on the substrate, wherein the overlayer, in combination with a portion of the substantially planar surface forms a cavity that defines a channel that contains the electrolyte, wherein the three electrodes are disposed on the portion of the substantially planar surface and separated from each other along a long axis of the channel,
wherein an electrolyte is disposed within the channel,
wherein applying the first set of voltages to the three electrodes electrostatically attracts a negatively charged biomolecule into the channel;
during a second period of time that is subsequent to the first period of time, applying a second set of voltages relative to the ground potential of the electrolyte to the three electrodes so as to electrostatically retain the negatively charged biomolecule inside the channel; and
during a third period of time that is subsequent to the second period of time, applying a third set of voltages relative to the ground potential of the electrolyte to the three electrodes so as to electrostatically expel the negatively charged biomolecule from the channel.

11. The method of claim 10, wherein every voltage of the first set of voltages, the second set of voltages, and the third set of voltages has a magnitude relative to the ground potential of the electrolyte that is less than 2 volts.

12. The method of claim 10, wherein a second electrode of the three electrodes is located between a first electrode and a third electrode of the three electrodes, wherein applying the first set of voltages to three electrodes comprises applying positive voltages to the first and second electrodes and a negative voltage to the third electrode relative to a ground potential of the electrolyte, wherein applying the second set of voltages to three electrodes comprises applying a positive voltage to the second electrode and negative voltages to the first and third electrodes relative to the ground potential of the electrolyte, and wherein applying the third set of voltages to three electrodes comprises applying a positive voltage to the third electrode and negative voltages to the first and second electrodes relative to the ground potential of the electrolyte.

13. A method for fabricating a device, the method comprising:
forming three electrodes on a substantially planar surface of a substrate; and
disposing an overlayer on the substrate, thereby forming a channel that is defined by a cavity formed by a combination of the overlayer and a portion of the substantially planar surface such that the three electrodes are disposed on the portion of the substantially planar surface and separated from each other along a long axis of the channel.

14. The method of claim 13, wherein the overlayer comprises a polymeric material, wherein the method further comprises forming the overlayer via a casting process such that the overlayer has formed therein the cavity.

15. The method of claim 14, wherein disposing the overlayer on the substrate comprises exposing the substrate to a vacuum ultraviolet ozone environment prior to contacting the overlayer to the substrate, thereby enhancing bonding of the overlayer to the substrate.

16. The method of claim 12, further comprising:
forming a layer of insulation on the substrate such that the three electrodes are at least partially covered by the layer of insulation.

17. The method of claim 16, wherein the layer of insulation comprises alumina.

18. The method of claim 12, wherein the substrate comprises sapphire.

19. The method of claim 18, wherein the overlayer and substrate are optically transparent to at least one band of wavelengths of visible light, thereby allowing an interior of the channel to be optically interrogated from outside of the substrate and overlayer.

20. The method of claim 12, wherein the channel has a substantially rectangular cross-sectional geometry having a height above the substantially planar surface that is less than 110 microns.
